(19) United States
(12) Patent Application Publication
(10) Pub. No.: US 2011/0048770 A1
(43) Pub. Date: Mar. 3, 2011

(54) INJECTION MOLDED FERRULE FOR COFIRED FEEDTHROUGHS

(75) Inventors: Markus Reiterer, Plymouth, MN (US); Brad C. Tischendorf, Minneapolis, MN (US); Andrew Thom, Maple Grove, MN (US)

(73) Assignee: Medtronic Inc., Minneapolis, MN (US)

(21) Appl. No.: 12/693,772

(22) Filed: Jan. 26, 2010

Related U.S. Application Data
(60) Provisional application No. 61/238,515, filed on Aug. 31, 2009.

(51) Int. Cl. H01B 17/30; B22F 7/04

(52) U.S. Cl. 174/152 GM; 419/9

(57) ABSTRACT

Feedthrough assemblies and methods of manufacturing feedthrough assemblies are provided. Methods include molding a ferrule comprising titanium using metal injection molding and positioning the ferrule about at least a portion of an insulator, the insulator comprising alumina. Methods also include overmolding a ferrule about at least a portion of an insulator using metal injection molding, the ferrule comprising titanium and the insulator comprising alumina. Sintering densifies the ferrule and provides a hermetic seal between the ferrule and insulator. The insulator may be fired or unfired prior to sintering of the ferrule.

### CROSS-REFERENCE TO RELATED APPLICATIONS

This application claims the benefit of U.S. Provisional Application No. 61/238,515, filed on Aug. 31, 2009. The entire disclosure of the above application is incorporated herein by reference.

### INTRODUCTION

The present technology relates to electrical feedthroughs and methods of fabricating feedthroughs, including feedthroughs for use with implantable medical devices.

Electrical feedthroughs serve the purpose of providing an electrical circuit path extending from the interior of a hermetically sealed case or housing to an external point outside the case. Implantable medical devices (IMDs) such as implantable pulse generators (IPGs) for cardiac pacemakers, implantable cardioverter/defibrillators (ICDs), nerve, brain, organ, and muscle stimulators and implantable monitors, and the like, employ such electrical feedthroughs through their case to make electrical connections with leads, electrodes, and sensors located outside the case.

Such feedthroughs typically include a ferrule adapted to fit within an opening in the case, one or more conductors, and a non-conductive hermetic glass or ceramic seal which supports and electrically isolates each such conductor from the other conductors passing through it and from the ferrule. The IMD case is typically formed of a biocompatible metal, e.g., titanium, although non-conductive ceramics materials have been proposed for forming the case. The ferrule is typically of a metal that can be welded or otherwise adhered to the case in a hermetically sealed manner.

Single pin feedthroughs supported by glass, sapphire, and ceramic are used with hermetically sealed IMD cases. In response to changing needs, however, smaller case sizes are being used and the numbers of external leads, electrodes, and/or sensors that are coupled with the circuitry of the IMD have increased. Consequently, use of relatively large single pin feedthroughs is no longer feasible for many applications, and numerous multiple conductor feedthroughs are used or proposed for use that fit within smaller sized case openings that provide two, three, four, or more conductors within a single ferrule.

Different insulator structures and conductor structures are known in the art of multiple conductor feedthroughs where the insulator structure also provides a hermetic seal to prevent entry of body fluids through the feedthrough and into the housing of the IMD. Conductors typically comprise electrical wires or pins that extend through a glass and/or ceramic layer within a metal ferrule opening as shown, for example, in commonly assigned U.S. Pat. Nos. 4,991,582, 5,782,891, and 5,866,851 or through a ceramic case as shown in the commonly assigned U.S. Pat. No. 5,782,891 and in U.S. Pat. No. 5,470,345. It has also been proposed to use co-fired ceramic layer substrates provided with conductive paths formed of traces and vias as disclosed, for example, in U.S. Pat. Nos. 4,420,652, 5,434,358, 5,782,891, 5,620,476, 5,683,435, 5,750,926, and 5,973,906.

Such multi-conductor feedthroughs can have an internally disposed portion configured to be disposed inside the case for connection with electrical circuitry and an externally disposed portion configured to be disposed outside the case that is electrically coupled with connector elements for making connection with leads, electrodes, and/or sensors. Elongated lead conductors extending from the connector elements can act as antennae and can collect stray electromagnetic interference (EMI) signals that may interfere with normal IMD operations. At certain frequencies, for example, EMI can be mistaken for telemetry signals and cause an IPG to change operating mode.

This problem is addressed in certain of the above-referenced patents by incorporating a capacitor structure upon the internally facing portion of the feedthrough ferrule coupled between each feedthrough conductor and a common ground, the ferrule, to filter out any high frequency EMI transmitted from the external lead conductor through the feedthrough conductor. Feedthrough capacitors originally were discrete capacitors but presently can take the form of chip capacitors that are mounted as shown in the above-referenced '891, '435, '476, and '906 patents and further in U.S. Pat. Nos. 5,650,759, 5,896,267 and 5,959,829, for example. Or the feedthrough capacitors can take the form of discrete discoidal capacitive filters or discoidal capacitive filter arrays as shown in commonly assigned U.S. Pat. Nos. 5,735,884, 5,759,197, 5,836,992, 5,867,361, and 5,870,272 and further U.S. Pat. Nos. 5,287,076, 5,333,095, 5,905,627 and 5,999,398. These patents disclose use of discoidal filters and filter arrays in association with conductive pins that are of relatively large scale and difficult to miniaturize without complicated manufacture. It is desirable to further miniaturize and simplify the fabrication of the multi-conductor feedthrough assembly.

Although feedthrough filter capacitor assemblies of the type described above have performed in a generally satisfactory manner, the manufacture and installation of such filter capacitor assemblies can be relatively time consuming and therefore costly. For example, installation of the discoidal capacitor into the small annular space between the terminal pin and ferrule as shown in a number of these patents can be a difficult and complex multi-step procedure to ensure formation of reliable, high quality electrical connections. Other problems have arisen when chip capacitors have been coupled to conductive trace and via pathways of co-fired multi-layer metal-ceramic substrates disclosed in the referenced '652, '358, '891, '476, '435, '926, and '906 patents. The conductive paths of the feedthrough arrays and attached capacitors may suffer from high inductance, which may have the effect of failing to attenuate EMI and other unwanted signals, characterized as “poor insertion loss.”

In addition, a high integrity hermetic seal for medical implant applications prevents the ingress of body fluids into the IMD. Even a small leak rate of such body fluid penetration can, over a period of many years, build up and damage sensitive internal electronic components. This may cause catastrophic failure of the implanted device. The hermetic seal for medical implant (as well as space and military) applications is typically constructed of highly stable alumina ceramic or glass materials with very low bulk permeability. The above-described feedthroughs formed using traditional ceramic, glass, or metal-ceramic co-fired substrates generally require additional polymer protection to remain hermetic under implant conditions due to instability of the ceramic-to-metal interfaces in body fluids. This can cause both hermetic loss of the seal itself and cracking of the ceramic due to stresses that developed from brazing and welding processes.

Accordingly, there is a need for electrical feedthroughs that are improved with respect to one or more of the aforementioned aspects.

### SUMMARY

The present technology includes methods and articles of manufacture that relate to metal injection molded ferrules for co-fired feedthroughs having hermetic seals.

A feedthrough assembly includes a ferrule positioned about at least a portion of an insulator, such as a high temperature co-fired ceramic. The ferrule includes titanium and the insulator includes alumina. The ferrule and insulator provide a hermetic seal that can be helium leak tight without any brazing material between the ferrule and insulator.

A method of manufacturing a feedthrough assembly includes molding a ferrule comprising titanium using metal injection molding. The molded ferrule is positioned about at least a portion of an insulator comprising alumina. Sintering causes densification of the ferrule and bonds the ferrule to the insulator to provide a hermetic seal. The metal injection molding process may include injecting a mixture of titanium particles and binding material into a mold for the ferrule to form a green part. The green part is removed from the mold and may be subjected to debinding to form a brown part. The brown part is provided as the ferrule, is positioned about at least a portion of the insulator, and is sintered.

Another method of manufacturing a feedthrough assembly includes overmolding a ferrule about at least a portion of an insulator using metal injection molding. The ferrule includes titanium and the insulator includes alumina. The ferrule is sintered to densify and bond the ferrule to the insulator to provide a hermetic seal. The metal injection molding process may include injecting a mixture of titanium particles and binding material into a mold for the ferrule to form a green part, wherein the insulator is positioned within at least part of the mold so that the green part is formed about at least a portion of the insulator. The green part is then removed from the mold and subjected to debinding to form a brown part. The brown part is provided as the ferrule in the sintering step of the method.

A method of manufacturing a feedthrough assembly includes molding a ferrule comprising titanium using metal injection molding. The ferrule is positioned about at least a portion of a green unfired insulator comprising alumina. Sintering causes densification of both the ceramic insulator and ferrule and bonds the ferrule to the insulator to provide a hermetic seal. The metal injection molding process may include injecting a mixture of titanium particles and binding material into a mold for the ferrule to form a green part. The green ferrule is removed the mold and may be subjected to debinding to form a brown part. The brown part is provided as the ferrule, is positioned about at least a portion of the unfired green insulator, and the parts are sintered together.

Another method of manufacturing a feedthrough assembly includes overmolding a ferrule about at least a portion of a green unfired insulator using metal injection molding. The ferrule includes titanium and the insulator includes alumina. The ferrule and alumina insulator are sintered together to densify and bond the ferrule to the insulator to provide a hermetic seal. The metal injection molding process may include injecting a mixture of titanium particles and binding material into a mold for the ferrule to form a green part, wherein the green unfired insulator is positioned within at least part of the mold so that the green part is formed about at least a portion of the insulator. The green assembly is then removed from the mold and may be subjected to debinding to form a brown assembly. The brown assembly is then subjected to sintering to form the helium leak tight feedthrough assembly.

### DRAWINGS

The drawings described herein are for illustrative purposes only of selected embodiments and not all possible implementations, and are not intended to limit the scope of the present disclosure.

FIG. 1 illustrates a perspective view of an embodiment of a feedthrough constructed according to the present technology;

FIG. 2 illustrates a cross-sectional view of an embodiment of a feedthrough constructed according to the present technology; and

FIGS. 3A and 3B illustrate cross-sectional views of further embodiments of feedthroughs constructed according to the present technology.

### DETAILED DESCRIPTION

The following description of technology is merely exemplary in nature of the subject matter, manufacture and use of one or more inventions, and is not intended to limit the scope, application, or uses of any specific invention claimed in this application or in such other applications as may be filed claiming priority to this application, or patents issuing therefrom. The following definitions and non-limiting guidelines must be considered in reviewing the description of the technology set forth herein.

The headings (such as “Introduction” and “Summary”) and sub-headings used herein are intended only for general organization of topics within the present disclosure, and are not intended to limit the disclosure of the technology or any aspect thereof. In particular, subject matter disclosed in the “Introduction” may include novel technology and may not constitute a recitation of prior art. Subject matter disclosed in the “Summary” is not an exhaustive or complete disclosure of the entire scope of the technology or any embodiments thereof. Classification or discussion of a material within a section of this specification as having a particular utility is made for convenience, and no inference should be drawn that the material must necessarily or solely function in accordance with its classification herein when it is used in any given composition.

The citation of references herein does not constitute an admission that those references are prior art or have any relevance to the patentability of the technology disclosed herein. All references cited in the “Detailed Description” section of this specification are hereby incorporated by reference in their entirety.

The description and specific examples, while indicating embodiments of the technology, are intended for purposes of illustration only and are not intended to limit the scope of the technology. Moreover, recitation of multiple embodiments having stated features is not intended to exclude other embodiments having additional features, or other embodiments incorporating different combinations of the stated features. Specific examples are provided for illustrative purposes of how to make and use the apparatus and systems of this technology and, unless explicitly stated otherwise, are not intended to be a representation that given embodiments of this technology have, or have not, been made or tested.

As referred to herein, all compositional percentages are by weight of the total composition, unless otherwise specified. As used herein, the word “include,” and its variants, is intended to be non-limiting, such that recitation of items in a list is not to the exclusion of other like items that may also be useful in the materials, compositions, devices, and methods of this technology. Similarly, the terms “can” and “may” and their variants are intended to be non-limiting, such that recitation that an embodiment can or may comprise certain elements or features does not exclude other embodiments of the present technology that do not contain those elements or features.

“A” and “an” as used herein indicate “at least one” of the item is present; a plurality of such items may be present, when possible. “About” when applied to values indicates that the calculation or the measurement allows some slight imprecision in the value (with some approach to exactness in the value; approximately or reasonably close to the value; nearly). If, for some reason, the imprecision provided by “about” is not otherwise understood in the art with this ordinary meaning, then “about” as used herein indicates at least variations that may arise from ordinary methods of measuring or using such parameters. In addition, disclosure of ranges includes disclosure of all distinct values and further divided ranges within the entire range.

The present technology relates to a co-fired feedthrough assembly comprising an injection molded titanium ferrule. The feedthrough assembly is hermetically sealed without the use of brazing material and can be used in an implantable medical device (IMD). The feedthrough assembly can further incorporate a filter capacitor to prevent or reduce electromagnetic interference (EMI).

Manufacture of the feedthrough assembly can include a biocompatible metallic ferrule formed by injection molding of titanium where the ferrule is incorporated into the co-fired feedthrough assembly without the use of brazing material. The feedthrough assembly provides a hermetic seal between the conductive ferrule and nonconductive insulator without the use of brazing material, preventing passage or leakage of fluids into the IMD, for example. The present feedthrough assemblies may be used in various IMDs, such as cardiac pacemakers, cardioverter defibrillators, and the like, to decouple and shield internal electronic components of the medical device from undesirable EMI signals.

Metal injection molding is used to form a titanium ferrule for a co-fired feedthrough. The ferrule may be molded separately or may be directly molded over a co-fired or unfired insulator. In each case, a permanent, hermetic joint between the insulator and the titanium ferrule is established by a sintering process. As the assembled feedthrough shrinks during sintering, densification closes the pores in the titanium ferrule so that may become helium leak tight and a hermetic joint is formed between the insulator and the ferrule. The mating surface on the insulator surface may be metallized with a refractory material, e.g. niobium, titanium, molybdenum, tungsten, or combinations thereof. The metallization may be applied by standard physcial or chemical deposition methods that are commonly used in the industry. However, no reflowed brazing material such as high purity gold is used between the ferrule and insulator at any point in manufacture of the feedthrough assembly.

The insulator may comprise high temperature co-fired ceramic (HTCC) such as liquid-phase, sintered alumina with platinum metallization, which may be used to form one or more vias, planar internal paths, and surface pads. For example, the insulator may be about 92% alumina and the sintering temperature of the HTCC may be about 1550° C., whereas a temperature of about 1300° C. is estimated as the sintering temperature for the metal injection molded titanium ferrule, therefore allowing sequential sintering of the ferrule and the insulator. For example, sintering temperature (Tₛ) may be approximated based on melting temperature (Tₘ) using the equation: Tₛ=0.8×Tₘ, with temperature values in Kelvin. In some embodiments, the insulator consists essentially of high temperature co-fired ceramic, and in some embodiments, the insulator consists of high temperature co-fired ceramic.

The present feedthrough assemblies can forgo joining materials used for joining assembly components (e.g., braze and/or glass seals) and elimination of these materials simplifies fabrication of the feedthrough assembly and also saves time. For example, ceramics are often joined to metals by either brazing or glass sealing. However, there can be problems with the joining material. Immersion tests have shown that the joining material is a path for degradation and/or leakage of a feedthrough, which may compromise the hermetic seal of an IMD, for example. Building a feedthrough without joining material can solve this aspect of feedthrough degradation.

Manufacture of the present feedthrough assemblies also allows for the formation of complex parts through the use of metal injection molding. For example, the injection molding process is amenable to forming titanium ferrules for feedthrough assemblies having complex geometries based on the insulator design and/or the opening of an IMD case. Sequential sintering of the ferrule and the ceramic insulator also allows direct joining of bulk alumina and bulk titanium by bonding and hermetically sealing without having to provide joining material.

The present feedthrough assemblies can include features of the nonconductive, co-fired metal-ceramic substrates for insulators and related methods of making and using as described in U.S. Pat. No. 6,660,116 to Wolf et al. However, in the present technology, no joining material (e.g., braze material) is used in assembly and sealing of the ferrule in the feedthrough assembly and the present ferrule is further formed by metal injection molding of titanium.

In some embodiments, the present technology includes an internally grounded feedthrough filter capacitor assembly comprising a feedthrough supporting a filter discoidal capacitor as described in U.S. Pat. No. 6,660,116 to Wolf et al. The feedthrough portion of the assembly includes one or more terminal pins or pads that provide for coupling, transmitting, and receiving electrical signals, while hermetically sealing the interior of the medical device against ingress of patient body fluids that could otherwise disrupt device operation or cause instrument malfunction. In some cases, it may be desirable to attach the filter capacitor to the feedthrough for suppressing or decoupling undesirable EMI signals and noise transmission into the interior of the medical device along the terminal pins.

The feedthrough assembly includes an electrically conductive ferrule formed by metal injection molding of titanium. The ferrule includes an inner wall surface that defines a ferrule opening and extends between opposed internal and external sides. When the metal injection molded ferrule is fitted into an IMD case opening, the internally facing side is adapted to face toward the inside of the case, and the externally facing side is adapted face toward the exterior of the case.

The electrically conductive ferrule may further include a relatively thin welding flange extending outwardly of the ferrule wall away from the ferrule opening for a predetermined distance, defining a flange width. The surrounding flange may extend from the ferrule to facilitate attachment of the feedthrough to the casing of an implantable medical device. The flange is formed to have a relatively thin flange thickness for reducing stress caused by thermal welding energy applied to the ferrule in the process of welding the flange to the case around the case opening. The method of attachment may be by laser welding or other suitable methods.

The ferrule may be formed by metal injection molding of titanium; however, additional metals, metal alloys, mixtures and combinations thereof may be included. In some cases, pure titanium, e.g. commercially pure grades of Ti, may be used as the ferrule material as it is lightweight and can be chemically and biologically compatible. The titanium alloy designated Ti-6Al-4V may also be used. Use of titanium further provides an electrically conductive ferrule material. And the ferrule may have various geometries, such as round, rectangular, oblong, or various complex shapes as afforded and permitted by the metal injection molding process. For example, the ferrule and/or the insulator may have a geometry such that the ferrule cannot be separately metal injection molded and then positioned about the insulator. Insets or outsets in the insulator design may make it difficult or impossible to position a ferrule about such an insulator. However, the metal injection molding process allows the ferrule to be made in place and accommodate such insets and/or outsets. The ferrule may also be subjected to a machining process after metal injection molding to provide the finished ferrule for use in the feedthrough assembly.

Titanium for metal injection molding of the ferrule may be in the form of nano-titanium, which includes titanium having a grain size of less than about 200 nanometers, and preferably from about 100 nanometers to about 500 nanometers. Examples of nano-titanium are illustrated in U.S. Pub. No. 2007/0183118 to Fu et al.

Metal injection molding may use metal powder. Several techniques to produce industrial quantities of metal powders have been developed. Most of them allow controlling grain size and grain size distribution. Powders are made by grinding, chemical reactions, or melting operations. Refractory metal powders, such as titanium, can be produced by high temperature reduction of nitrides or carbides, and nano-powders are frequently produced via a metal-organic reaction. Another promising technique for this application is gas-atomization, where a molten jet of metal, produced by a plasma or flame jet, is sprayed into a gas stream. The combination of turbulent flow of the metal and the rapid expansion of the gas causes extremely fine dispersion of the metal and rapid cooling. Tight control of the process condition results in very small powders with a narrow particle size distribution. Alternatively, the hydride-dehydride process can be used, where coarse pieces or solid scrap of the metal are hydrogenated to produce a brittle material that is subsequently ground under argon cover gas at medium temperatures resulting in micro-meter sized powders.

In some embodiments, the metal used for the metal injection process is pure titanium or substantially pure titanium. However, the titanium may include titanium alloys and mixtures with other metals and metal alloys. These metals and alloys may include, for example, titanium alloys such as titanium-6Al-4V, titanium-niobium, nickel-titanium, or titanium-vanadium, niobium, platinum, molybdenum, zirconium, tantalum, vanadium, tungsten, iridium, rhodium, ruthenium, palladium, silver, stainless steels, nickel super alloys, nickel-cobalt-chromium-molybdenum alloy (e.g., MP35N®), alloys of these metals, and mixtures and combinations thereof. The properties of the chosen metal alloy can be improved by the addition of a reinforcing particulate phase consisting of materials which are thermodynamically more stable then the base alloy at the sintering temperatures. These materials may include, for example, borides, carbides and oxides of titanium, zirconium, niobium, tantalum, and aluminum.

Methods of making or forming ferrules for feedthrough assemblies by metal injection molding are provided. Suitable metal injection molding methods and steps include those described in U.S. Pat. No. 6,010,803 to Heller, Jr. et al. Additional methods, aspects, and features of metal injection molding also include those known in the art and those disclosed by the following sources, which are incorporated herein by reference: “Metal Molding Maestros,” Injection Molding (August 1995); “Powder Injection Molding: Cross-Fertilization at PIM '95,” Injection Molding (October 1995); “Powder Injection Molding Breaks New Ground,” Plastics Technology (August 1994); Randall M. German, Powder Injection Molding, Metal Powder Industries Federation, Princeton, N.J. (1990); and “Metal Injection Molding” by Richard Drewes, Product Design and Development (November 1994). The various methods and apparatuses described are for illustrative purposes only and are not intended to limit the present technology.

In general, the metal injection molding process begins by designing and making a suitable mold. Next, titanium particles generally having spherical shapes, for example with a nominal diameter from about 0.10 μm to about 75 μm, are mixed with a binding material, which may be a blend of polymers, wax, and other materials. A thermal mechanical process is used to mix the combination of binder and titanium particles, for example including about 40% binder and about 60% titanium particles by weight, where the mixture is then pelletized and injected into the mold. This produces a “green part” which may be about 19% to about 25% larger than the finished product, post-sintering. The green part is then subjected to a debinding process where about 90% of the binding material is removed through one or more thermal, solvent, and/or catalytic reactions. The resulting “brown part” is then is assembled with the insulator or high temperature co-fired ceramic (HTCC) prior to sintering. Subsequent heating and sintering results in sequential sintering of the ferrule and the ceramic insulator causing direct joining of the alumina and titanium by bonding and hermetically sealing without having to provide a brazing material. The ferrule is sintered by heating to about 80% of the melting point for titanium. Sintering shrinks the brown part (ferrule) by about 17% to about 22% to nearly full density; i.e., densification. The ferrule and HTCC portion of the feedthrough assembly is then complete with no further annealing steps or brazing steps required.

In some embodiments, metal injection molding can be used to overmold a ferrule about a substrate; e.g., a cofired ceramic insulator. For example, the mold can be loaded with a prefabricated or partially fabricated substrate where the substrate is positioned within at least part of the mold cavity and can help to form part of the geometry of the metal injection molded ferrule. In this way, the ferrule can be metal injection molded at or near its final position with respect to the insulator in the final feedthrough assembly. Overmolding also allows the green part ferrule to be in direct contact with the substrate. Subsequent debinding and densification following sintering provides bonding between the directly contacting ferrule and insulator to form a hermetic seal. There is no need to provide a braze material on the substrate at the position where the ferrule is over-molded.

Metal injection molding can use pelletized titanium mixed with a binder in a debinding system, called catalytic debinding, which yields ferrules that are dimensionally stable. A debinding system is available from Phillips Origen Powder Metal Molding (Menomonie, Wis.). The molding can be performed on a conventional molding press used for injection molding of plastics, but with an altered profile on the screw. The mold can be run hot to increase the flow rate of the material, where hot oil may be used to heat the mold, for example. The mold can also be equipped with one or more pressure transducers to indicate the pressure in the mold cavity in order to adjust molding parameters as necessary. The green ferrule can undergo debinding in a gas-tight oven at elevated temperature. The brown ferrule can then be sintered along with the HTCC in an atmosphere controlled high temperature oven.

In some embodiments, methods of making a ferrule and/or feedthrough assembly include the following aspects. The metal injection molding process can include design and fabrication of a suitable mold, where the mold can be reusable and can further include multiple cavities to form multiple molded products that may be similar or different. With further respect to mold design, the mold cavities can be designed and proportioned to account for the expected size and shape changes that occur between the green part to the finished ferrule in the feedthrough assembly.

The material for injection into the mold can include metal particles generally having spherical shapes with a nominal diameter of less than about 75 microns that are mixed with a binder, including, for example, a blend of polymers, wax, and other materials. A thermal mechanical process is used to mix a combination of about 30-50% binder and about 70-50% metal particles. The mixture is then pelletized and injected into one more mold cavities. This produces the green part which can be about 19-25% larger than the finished product. The green part is subjected to debinding where about 90% of the binding material is removed through thermal, solvent, and/or catalytic reactions. The resulting brown part is then assembled with the HTCC and sintered by heating to about 80% of the melting point for titanium. Sintering shrinks the brown part by about 17-22% to nearly full density. The bonded and hermetically sealed product is then complete with no further annealing steps being required.

In some methods, metal injection molding can employ a mold that integrates various features into the ferrule design. For example, the mold can produce a surrounding flange completely integral with main body of the ferrule. The flange may be used to facilitate coupling of the resulting feedthrough assembly within the cover of an IMD, for example, where the feedthrough is subsequently laser welded in place. The mold may also include other design features as desired. In some cases, an IMD cover or lid is produced through the process of metal injection molding, where the molded cover or lid further includes one or more integral feedthrough ferrules. Examples of a cover and integrated ferrule include those described by U.S. Pat. No. 6,010,803 to Heller, Jr. et al. with the proviso that the present technology does not employ any braze material or braze joint between the nonconductive insulator/substrate and the metal injection molded titanium cover and integrated ferrule.

The insulator can comprise a ceramic material, such as alumina, a toughened alumina, sapphire, silicon nitride, silicon carbide, zirconia, zircon, and combinations thereof. Anywhere from a portion to the entire insulator is positioned within the ferrule opening so that insulator contacts the inner wall surface of the ferrule opening. Where the feedthrough assembly is a capacitive filtered feedthrough assembly, the insulator can further comprise a multi-layer, co-fired metal-ceramic substrate. The substrate can be dimensioned and shaped to fit within the ferrule opening with the edge of the substrate in close relation to the ferrule inner wall surface. Unlike other feedthrough assemblies, the substrate edge is not brazed to the ferrule inner wall surface using a substrate-ferrule braze joint, as the sintering and densification process bonds the ferrule and the substrate to provide a hermetic seal.

The metal-ceramic substrate may include a plurality of planar ceramic layers. Each ceramic layer may be shaped in a green state to have a layer thickness and a plurality of via holes extending therethrough between an internally facing layer surface and an externally facing layer surface. The co-fired metal-ceramic substrate ceramic material may comprise alumina, toughened alumina, ziconia, glass-ceramic materials, and mixtures thereof. In some cases, the ceramic material may have a coefficient of thermal expansion (CTE) that is similar or substantially similar to the CTE of the metal injection molded titanium ferrule.

The insulator can further include one or more bores to receive one or more terminal pins, vias and pads, and/or planar internal paths, passing therethrough. These terminal pins, vias, pads, and paths may comprise materials such as niobium, tantalum, nickel-titanium (e.g., NITINOL™), titanium, beta titanium, titanium alloys, stainless steel, molybdenum, tungsten, platinum, platinum-iridium, palladium, palladium alloys, and combinations thereof. Where there is more than one terminal pin, the pins may be spaced, arrayed, and/or configured in several ways. For example, pin-to-pin spacing of two single pin or unipolar feedthroughs may be less then about 0.125 inches and capacitive filtered feedthroughs may provide a spacing less then 0.050 inches between adjacent conductive paths.

In some embodiments, fabrication of a feedthrough assembly according to the present technology may include the following aspects, in further reference to those provided by U.S. Pat. No. 6,660,116 to Wolf et al. The feedthrough assembly may be a multi-layer, cofired metal-ceramic substrate adapted to be joined with a capacitive filter array and metal injection molded ferrule. Ceramic layers may be tape cast from conventional or co-fired ceramic materials that have a CTE compatible with the CTE of the titanium material of the ferrule. For example, about 88% to about 96% alumina (Al₂O₃) is tape cast using conventional “green sheet” techniques on glass-ceramic or MYLAR™ support materials. In general, such techniques start with a ceramic slurry formed by mixing a ceramic particulate, a thermoplastic polymer, and solvents. The slurry is spread into ceramic sheets of predetermined thickness, e.g., about 0.006-0.010 inches thick, from which the solvents are volatized, leaving self-supporting flexible green sheets.

Holes that will be filled with conductive material to form the vias of each conductive path can be made using various techniques, such as drilling, punching, laser cutting, etc., through each of the green sheets from which the ceramic layers are formed. The vias may have a size appropriate for the path spacing, with about a 0.004 inch diameter hole being appropriate for 0.020 inch center to center path spacing.

The via holes are filled with a paste of refractory metal, e.g., tungsten, molybdenum, platinum, niobium, or tantalum paste, preferably using screen printing. Conductive traces are also applied to particular surface areas of the ceramic layers over the vias. The traces may comprise an electrical conductor, such as a refractory metal paste as mentioned above, that may be deposited on the green sheets using conventional techniques. The traces may be deposited, sprayed, screened, dipped, plated, etc. onto the green sheets. The traces may have a center to center spacing as small as about 0.020 inch (smaller spacing may be achievable as trace forming technology advances) so that a conductive path density of associated vias and traces of up to about 50 or more paths per inch may be achieved.

In these ways, the via holes are filled and the conductive traces are applied to the green sheets before they are stacked and laminated, for example by using a mechanical or hydraulic press. The stacked and laminated ceramic layers are trimmed to external edge dimensions sufficient to fit within the corresponding metal injection molded ferrule opening, taking into account any shrinkage that may occur from co-firing of the stacked layers.

The assembly of stacked, laminated, and trimmed green sheets is then co-fired to drive off the resin and sinter the particulate body together into a multi-layer metal-ceramic substrate of higher density than the green sheets. The green sheets shrink in thickness when fired such that about a 0.006 inch thick green sheet typically shrinks to a layer thickness of about 0.005 inch. The green sheets may be fired using conventional techniques. The outer edge and the inward and outward facing substrate surfaces can be machined and polished to size and finish specifications.

In some embodiments, the co-fired substrate is first sintered by itself, fitted with an unsintered ferrule, and the substrate with the fitted ferrule is then sintered to densify the ferrule and seal the ferrule to the substrate. The co-fired substrate may also be included within the mold and the ferrule formed by metal injection molding about the substrate. Subsequent debinding and sintering allows the ferrule to remain in place with respect to the substrate thus simplifying manufacture. As the feedthrough assembly cools, the ferrule may contract more than the substrate, which can put the co-fired substrate in a state of compression with bonding providing a hermetic seal.

In some embodiments, the unfired green co-fired substrate, fitted with an unsintered ferrule, and the substrate with the fitted ferrule is then sintered in a single step to densify the ceramic and ferrule and seal the ferrule to the substrate at the same time. The unfired green co-fired substrate may also be included within the mold and the ferrule formed by metal injection molding about the substrate. Subsequent debinding and sintering allows the ferrule to remain in place with respect to the substrate thus simplifying manufacture. As the feedthrough assembly cools, the ferrule may contract more than the substrate, which can put the co-fired substrate in a state of compression with bonding providing a hermetic seal.

Hermetic sealing of the present feedthrough assemblies may be ascertained using the methods illustrated in U.S. Pat. No. 6,349,025 to Fraley et al., including helium leak testing as described therein.

The present feedthrough assemblies are useful with medical devices, preferably implantable devices such as pacemakers, cardiac defibrillators, cardioverter defibrillators, cochlear implants, neurostimulators, internal drug pumps, deep brain stimulators, hearing assist devices, incontinence devices, obesity treatment devices, Parkinson's disease therapy devices, bone growth stimulators, and the like.

### Example 1

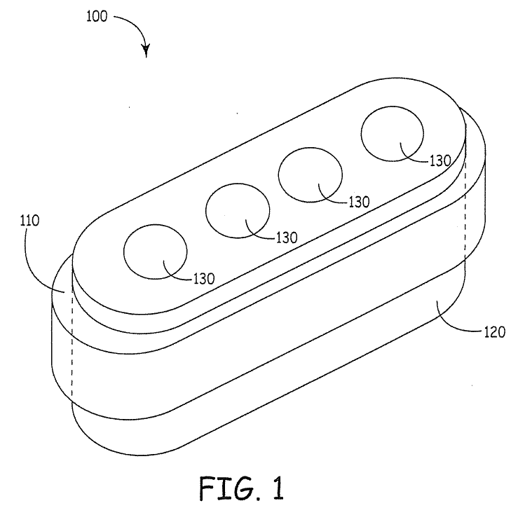

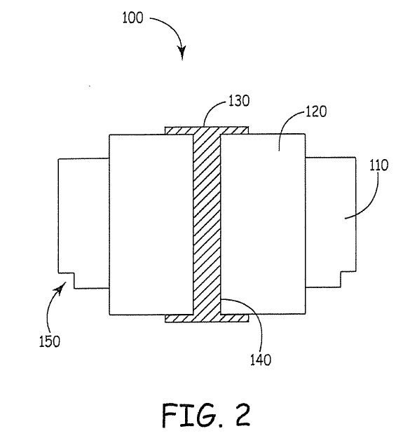

With reference to FIGS. 1 and 2, an embodiment of a feedthrough assembly 100 constructed in accordance with the present technology is shown in perspective and cross-sectional views, respectively.

The feedthrough assembly 100 includes a metal injection molded titanium ferrule 110. The ferrule 110 can be over-molded about a cofired ceramic insulator 120 using a metal injection molding process. Upon sintering, densification causes the ferrule 110 and insulator 120 to bond and form a hermetic seal without any joining material, such as braze or solder, present between the ferrule 110 and insulator 120. The insulator 120 can comprise alumina (i.e., Al₂O₃) that can electrically isolate one or more conductive pads 130 and vias 140 comprising platinum, for example. The ferrule 110 can include a flange 150 to facilitate welding of the feedthrough assembly within an opening of an IMD cover, for example. Variations of the insulator 120 include where the electrical connections including the pads 130 and vias 140 are capacitively filtered and the insulator 120 may also be a multi-layer, co-fired metal-ceramic substrate. The present technology simplifies feedthrough assemblies as there is no requirement or use of any braze material or braze joint between the insulator/substrate and the metal injection molded titanium ferrule.

### Example 2

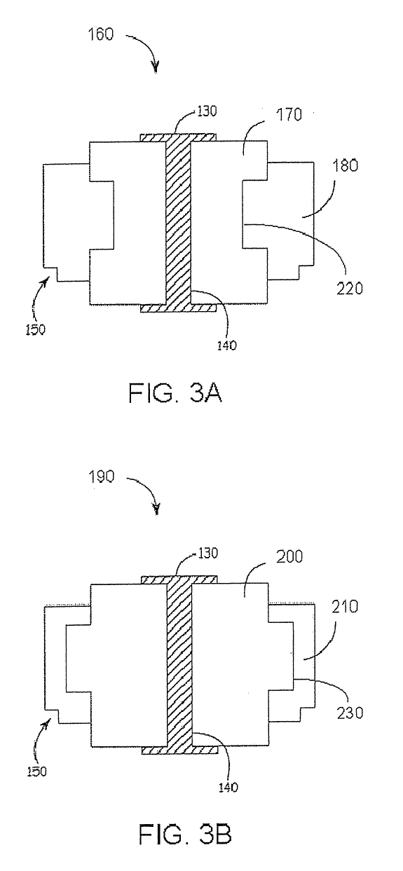

With reference to FIGS. 3A and 3B, two further embodiments of feedthrough assemblies 160, 190 constructed in accordance with the present technology are shown in cross-sectional view.

The feedthrough assemblies 160, 190 include metal injection molded titanium ferrules 180, 210 that are over-molded about insulators 170, 200 using a metal injection molding process. In such cases, the insulator is placed within at least a portion of the mold. Use of metal injection molding allows the ferrule to be molded about an insulator geometry that precludes separate molding of the ferrule followed by fitting the ferrule about the insulator. One or more features of the insulator may make it difficult or even impossible to fit a separately molded ferrule about an insulator.

As shown in FIG. 3A, an insulator 170 may have an inset portion 220 that is filled by a ferrule 180 when the ferrule 180 is over-molded about the insulator 170. As shown in FIG. 3B, an insulator 200 may have an outset portion 230 that is surrounded by a ferrule 210 when the ferrule 210 is over-molded about the insulator 200. In these embodiments, neither ferrule 180, 210 can be slid onto or off of the insulator 170, 200 due to the respective inset 220 and outset 230 portions. Over-molding of the insulator allows a hermetic seal to be formed without the use of brazing material and where the insulator geometry prevents fitment of a separate ferrule about the insulator.

The embodiments and the examples described herein are exemplary and not intended to be limiting in describing the full scope of apparatus, systems, and methods of the present technology. Equivalent changes, modifications and variations of some embodiments, materials, compositions and methods can be made within the scope of the present technology, with substantially similar results.

What is claimed is:

1. A method of manufacturing a feedthrough assembly comprising:
overmolding a ferrule about at least a portion of an insulator using metal injection molding, the ferrule comprising titanium and the insulator comprising a high temperature cofired ceramic alumina (HTCC) or a member selected from the group consisting of alumina, toughened alumina, sapphire, silicon nitride, silicon carbide, zirconia, zircon, and combinations thereof; and
sintering to densify the ferrule and provide a hermetic seal between the ferrule and insulator.

2. The method of claim 1, wherein the insulator is a fired insulator or an unfired insulator.

3. The method of claim 1, wherein the insulator and ferrule are co-sintered in a single step.

4. The method of claim 1, wherein a metallization layer comprising a refractory metal is positioned between at least a portion of the ferrule and insulator.

5. The method of claim 1, wherein the metal injection molding comprises:
injecting a mixture of titanium particles and binding material into a mold for the ferrule to form a green part, wherein the insulator is positioned within at least part of the mold so that the green part is formed about at least a portion of the insulator;
removing the green part from the mold; and
debinding the green part to form a brown part.

6. The method of claim 5, wherein the insulator forms part of the geometry of the metal injection molded ferrule in the mold.

7. The method of claim 1, wherein the sintering to densify the ferrule includes heating to about 1300° C.

8. The method of claim 1, wherein the hermetic seal is helium leak tight.

9. The method of claim 1, wherein the ferrule comprises titanium selected from the group consisting of pure titanium, nano-titanium, titanium-6Al-4V, titanium-vanadium, nickel-titanium, titanium-niobium, and mixtures thereof.

10. The method of claim 1, wherein the ferrule further comprises a member selected from the group consisting of niobium, platinum, molybdenum, zirconium, tantalum, vanadium, tungsten, iridium, rhodium, ruthenium, palladium, silver, stainless steel, nickel super alloy, nickel-cobalt-chromium-molybdenum alloy, alloys of these metals, and combinations thereof.

11. The method of claim 1, wherein the insulator further comprises at least one bore to receive an electrically conductive terminal pin or via and pad.

12. A feedthrough assembly manufactured according to the method of claim 1.

13. A method of manufacturing a feedthrough assembly comprising:
molding a ferrule using metal injection molding, the ferrule comprising titanium and the insulator comprising HTCC or a member selected from the group consisting of alumina, toughened alumina, sapphire, silicon nitride, silicon carbide, zirconia, zircon, and combinations thereof;
positioning the ferrule about at least a portion of an insulator; and
sintering to densify the ferrule and provide a hermetic seal between the ferrule and insulator.

14. The method of claim 13, wherein the insulator is a fired insulator or an unfired insulator.

15. The method of claim 13 wherein the insulator and ferrule are co-sintered in a single step.

16. The method of claim 13, wherein a metallization layer comprising a refractory metal is positioned between at least a portion of the ferrule and insulator.

17. The method of claim 13, wherein the metal injection molding comprises:
injecting a mixture of titanium particles and binding material into a mold for the ferrule to form a green part;
removing the green part from the mold; and
debinding the green part to form a brown part, wherein the brown part is provided as the ferrule in the positioning step.

18. The method of claim 13, wherein the sintering to densify the ferrule includes heating to about 1300° C.

19. The method of claim 13, wherein the hermetic seal is helium leak tight.

20. The method of claim 13, wherein the ferrule comprises titanium selected from the group consisting of pure titanium, nano-titanium, titanium-6Al-4V, titanium-vanadium, nickel-titanium, titanium-niobium, and mixtures thereof.

21. The method of claim 13, wherein the ferrule further comprises a member selected from the group consisting of niobium, platinum, molybdenum, zirconium, tantalum, vanadium, tungsten, iridium, rhodium, ruthenium, palladium, silver, stainless steel, nickel super alloy, nickel-cobalt-chromium-molybdenum alloy, alloys of these metals, and combinations thereof.

22. The method of claim 13, wherein the insulator further comprises at least one bore to receive an electrically conductive terminal pin or via and pad.

23. A feedthrough assembly manufactured according to the method of claim 13.

24. A feedthrough assembly comprising a ferrule positioned about a least a portion of an insulator, the ferrule comprising titanium and the insulator comprising HTCC or a member selected from the group consisting of alumina, toughened alumina, sapphire, silicon nitride, silicon carbide, zirconia, zircon, and combinations thereof, wherein the ferrule and insulator are hermetically sealed without the use of brazing or joining material or glass.

25. The feedthrough assembly of claim 24, further comprising a metallization layer comprising a refractory metal positioned between at least a portion of the ferrule and insulator.

26. The feedthrough assembly of claim 24, wherein the hermetic seal is helium leak tight.

27. The feedthrough assembly of claim 24, wherein the ferrule comprises titanium selected from the group consisting of pure titanium, nano-titanium, titanium-6Al-4V, titanium-nickel, titanium-vanadium, titanium-niobium, and mixtures thereof.

28. The feedthrough assembly of claim 24, wherein the ferrule further comprises a member selected from the group consisting of niobium, platinum, molybdenum, zirconium, tantalum, vanadium, tungsten, iridium, rhodium, ruthenium, palladium, silver, stainless steel, nickel super alloy, nickel-cobalt-chromium-molybdenum alloy, alloys of these metals, and combinations thereof.

29. The feedthrough assembly of claim 24, wherein the insulator further comprises at least one bore, wherein the bore includes an electrically conductive terminal pin or via and pad.

30. The feedthrough assembly of claim 24, wherein the terminal pin or via and pad comprise a member of the group consisting of niobium, tantalum, nickel-titanium, titanium, beta titanium, titanium alloys, stainless steel, molybdenum, tungsten, platinum, platinum-iridium, palladium, palladium alloys, and combinations thereof.
